(19) United States
(12) Patent Application Publication
(10) Pub. No.: US 2010/0244685 A1
(43) Pub. Date: Sep. 30, 2010

(54) PLASMA DISPLAY PANEL WITH IMPROVED EXHAUST CONDUCTANCE

(75) Inventors: Soichi Watari, Miyazaki (JP); Koji Ohira, Miyazaki (JP); Nobuhiro Iwase, Miyazaki (JP)

Correspondence Address: MILES & STOCKBRIDGE PC, 1751 PINNACLE DRIVE, SUITE 500, MCLEAN, VA, 22102-3833, US

(73) Assignee: HITACHI PLASMA DISPLAY LIMITED, Miyazaki (JP)

(21) Appl. No.: 12/301,443

(22) PCT Filed: Jun. 27, 2006
(86) PCT No.: PCT/JP2006/312821

§ 371 Date: Nov. 18, 2008

(51) Int. Cl. H01J 17/49

(52) U.S. Cl. 313/585; 313/584

(57) ABSTRACT

A plasma display panel having a partition wall structure with improved exhaust conductance and which can forestall drops in emission efficiency is provided. A plasma display panel having a discharge gas sealed in a space between a pair of opposing substrates, a plurality of display electrodes extending in a transversal direction, address electrodes A extending in a longitudinal direction and intersecting the display electrodes 40, and a lattice-like partition wall 29 having longitudinal partition walls 29V and transversal partition walls 29H, and defining unit light-emitting regions C on one of the substrates. The transversal partition walls 29H defining the unit light-emitting regions have first transversal partition walls 29H-1 each separated by gap 30 running through in the transversal direction, and second transversal partition walls 29H-2 that are not separated by gaps running through in the transversal direction, the first transversal partition walls and the second transversal partition walls being provided alternately. As a result, one transversal wall of a first transversal partition wall, a second transversal partition wall, and another transversal wall of a different first transversal partition wall are connected, in this order, by the longitudinal partition walls 29V, such that the resulting connected units are disposed with the gaps 30 running through in the transversal direction interposed between the connected units.

### TECHNICAL FIELD

The present invention relates to a plasma display panel with improved exhaust conductance, and more particularly to a plasma display panel with improved exhaust conductance in a sealing operation, obtained by improving a lattice-like partition wall structure which is formed on a rear substrate and which defines unit light-emitting regions.

### BACKGROUND

Demand for plasma display panels (hereinafter, PDPs) having ever larger screen sizes has grown steadily in recent years. PDPs currently marketed are AC-type 3-electrode surface discharge PDPs, which have a front-side substrate having formed thereon plural display electrodes extending in a transversal direction, a dielectric layer covering the display electrodes, and a protective layer; and a rear-side substrate, having formed thereon plural address electrodes extending in a longitudinal direction, a lattice-like (also called a closed-shape, box-shape, or waffle-shape) partition wall (rib), for defining unit light-emitting regions (discharge cells) where the address electrodes and the display electrodes intersect each other, and a phosphor formed on the address electrodes and on the side walls of the partition wall.

The front-side substrate and the rear-side substrate are sealed with a discharge space interposed in between. In the sealing process, a sealing material is formed around the front-side substrate and the rear-side substrate, and then sealing is performed by way of a high-temperature treatment. The interior of the panel is degassed via vent holes and vent tubes formed on the rear-side substrate, whereafter a discharge gas such as a mixed gas of Ne and Xe is sealed in, and the vent tubes are tipped off.

FIGS. 1A and 1B are plan-view diagrams of a conventional partition wall. The partition wall 29 of FIG. 1A is a simple lattice-like partition wall that defines unit light-emitting regions C (discharge cells). In each unit light-emitting region C there are arranged a display electrode pair, extending in the transversal direction, and an address electrode, extending in the longitudinal direction (none of the electrodes are shown in the figure). In the partition wall 29 of FIG. 1B, partition walls 29H extending in the transversal direction are separated by gaps 30 running through in the transversal direction. Bus electrodes (not shown) of the display electrodes are formed at the positions of the gaps 30 and the partition walls 29H extending in the transversal direction. These partition wall structures are described in, for instance, Patent documents 1 and 2 below.

Emission efficiency can be enhanced by increasing the surface area of the phosphor that is excited upon discharge, by surrounding the four sides of the unit light-emitting regions C with the lattice-like partition wall and forming the phosphor up to the side walls of four partition walls. This allows preserving high luminance even with narrower unit light-emitting regions of finer structure. Further, the unit light-emitting regions C are enclosed by the lattice-like partition walls, which allows hence avoiding the occurrence of discharge interferences between adjacent unit light-emitting regions C in the up-and-down and left-right directions.

Patent document 1: Japanese Patent Application Laid-open No. 2000-311612

Patent document 2: Japanese Patent Application Laid-open No. 2002-83545

However, forming a lattice-like partition wall results in a lower exhaust conductance in the above-described sealing process, which is problematic. In the sealing step, specifically, the interior of the panel is degassed with the rear-side substrate and the front-side substrate glued to each other, to remove thereby impurities such as moisture and organic compounds from the interior of the panel. If the interior of the panel cannot be sufficiently degassed, the phosphor may degrade, giving rise to a drop in luminance, and there may also occur voltage fluctuations, which result in problems such as nonuniform display within the panel.

A lattice-like partition wall has a lower exhaust conductance (i.e. a higher exhaust resistance) than a stripe-like partition wall. Herein, low exhaust efficiency precludes forming a high-quality PDP.

In the partition wall structure of FIG. 1B there are gaps 30 above and below the unit light-emitting region C, and hence exhaust conductance in the transversal direction becomes higher, as does exhaust efficiency. In this partition wall structure, however, the partition wall is formed as a ladder in the transversal direction. Therefore, all the unit light-emitting regions C have T-shaped partition wall structures (29T in the figure), above and below. These T shapes cause the transversal partition walls to deform in the up-and-down direction on account of the thermal shrinkage that occurs in the longitudinal partition wall in a high-temperature firing step during formation of the partition wall. The unit light-emitting regions C become narrower on account of the deformation of the transversal partition walls. Accordingly, the opening ratio of the unit light-emitting regions C drops, whereby emission efficiency drops as well. The degree of deformation of the transversal partition walls due to thermal shrinkage has poor variation reproducibility, on account of the partition wall material, firing temperature and so forth. This may result in luminance unevenness within the screen.

There is thus a trade off between exhaust conductance and partition wall deformation in lattice-like partition walls, but both exhaust conductance and partition wall non-deformation need to be satisfactory.

### DISCLOSURE OF THE INVENTION

Therefore, it is an object of the present invention to provide a plasma display panel having a partition wall structure with improved exhaust conductance and which can forestall drops in emission efficiency.

With a view to achieving the above goal, a first aspect of the present invention is a plasma display panel having a discharge gas sealed in a space between a pair of opposing substrates, a plurality of display electrodes extending in a transversal direction, address electrodes extending in a longitudinal direction and intersecting the display electrodes, and a lattice-like partition wall having longitudinal partition walls and transversal partition walls, and defining unit light-emitting regions on one of the substrates. The transversal partition walls defining the unit light-emitting regions have first transversal partition walls each separated by gap running through in the transversal direction, and second transversal partition walls that are not separated by gaps running through in the transversal direction, the first transversal partition walls and the second transversal partition walls being provided alternately. As a result, one transversal wall of a first transversal partition wall, a second transversal partition wall, and another transversal wall of a different first transversal partition wall are connected, in this order, by the longitudinal partition walls, such that the resulting connected units are disposed with the gaps running through in the transversal direction interposed between the connected units.

In the first aspect, all the unit light-emitting regions are in contact with a gap running through in the transversal direction, at an upper or lower first transversal partition wall. The unit light-emitting regions have thus only one upper or lower T-shaped partition wall structure formed by the longitudinal partition walls and the transversal partition walls. This allows improving as a result exhaust conductance while lessening the influence of deformation caused by the T-shaped partition wall structures.

With a view to achieving the above goal, a second aspect of the present invention is a plasma display panel having a discharge gas sealed in a space between a pair of opposing substrates, comprising:

a plurality of display electrodes extending in a transversal direction, and address electrodes extending in a longitudinal direction and intersecting the display electrodes, which are provided on the pair of substrates; and
a lattice-like partition wall, formed on one substrate of the pair of substrates, and having longitudinal partition walls and transversal partition walls defining unit light-emitting regions where the display electrodes and address electrodes intersect each other,
wherein the transversal partition walls of the lattice-like partition wall comprise first transversal partition walls each separated by gap running through in a transversal direction, and second transversal partition walls that are not separated by gap running through in the transversal direction, the first transversal partition walls and the second transversal partition walls being provided alternately, and a pair of the first transversal partition walls and a second transversal partition wall therebetween are connected by the longitudinal partition wall to form a partition wall unit, the partition wall units being disposed separated from each other by the gaps running through in the transversal direction.

In the above second aspect, according to a preferable embodiment, the width of the second transversal partition walls is greater than the width of the first transversal partition walls or the width of the longitudinal partition walls, and the height of the second transversal partition walls is lower than the height of the first transversal partition walls or the height of the longitudinal partition walls. Accordingly, the exhaust conductance is improved at the second transversal partition walls.

In the above second aspect, according to a preferable embodiment, spaces are provided in the second partition transversal partition walls, in a plan view, and the spaces are surrounded by one pair of sub-transversal walls extending in the transversal direction, and by sub-longitudinal walls that connect the pair of sub-transversal walls.

In the above second aspect, according to a preferable embodiment, a pair of display electrodes and one address electrode are disposed in each of the unit light-emitting regions, the display electrodes each comprise a transparent electrode and a bus electrode in contact with the transparent electrode, and the bus electrodes of the display electrodes are disposed so as to overlap with the second transversal partition walls. And preferably, display electrodes disposed in adjacent unit light-emitting regions in the longitudinal direction are made common. According to the structure, a capacitor of the display electrodes relative to address electrodes is lowered.

With a view to achieving the above goal, a third aspect of the present invention is a plasma display panel having a discharge gas sealed in a space between a pair of opposing substrates, comprising:

a plurality of display electrodes extending in a transversal direction, and address electrodes extending in a longitudinal direction and intersecting the display electrodes, which are provided on the pair of substrates; and
a lattice-like partition wall, formed on one substrate of the pair of substrates, and comprising longitudinal partition walls and transversal partition walls defining unit light-emitting regions where the display electrodes and address electrodes intersect each other,
wherein the lattice-like partition wall comprises three mutually adjacent transversal partition walls and a plurality of the longitudinal partition walls connecting the three transversal partition walls, and partition wall units, which define two rows of adjacent unit light-emitting regions in the longitudinal direction, are arranged in a plurality, separated from one another by gaps running through in the transversal direction.

In the third aspect, two rows of unit light-emitting regions are in contact with gaps, running through in the transversal direction, disposed above and below the unit light-emitting regions. This allows improving exhaust conductance as a result. Furthermore, although T-shaped partition walls are formed at the upper and lower edges of the partition wall units, cross-shaped partition walls are formed in the middle, and hence deformation caused by thermal shrinkage in the T-shaped partition walls can be kept to a minimum in all the unit light-emitting regions.

In the above third aspect, according to a preferable embodiment, a middle transversal partition wall of the three transversal partition walls has a wider width and a lower height than the other transversal partition walls. According to a further preferable embodiment, the middle transversal partition wall of the three transversal partition walls has intermittent spaces extending in the transversal direction, and the display electrodes are formed above the gaps running through in the transversal direction between the partition wall units, and above the intermittent spaces extending in the transversal direction, the unit light-emitting regions being positioned between the display electrodes. The capacitance of the display electrodes can be lowered.

The exhaust conductance is improved, and a decrease in opening ratio due to a deformation of partition walls is improved.

### BRIEF DESCRIPTION OF THE DRAWINGS

FIGS. 1A and 1B are plan-view diagrams of a conventional partition wall.

FIGS. 2A and 2B are plan-view diagrams illustrating the relationship between partition wall structure and electrodes in a first embodiment.

FIGS. 3A and 3B are diagrams illustrating the thermal shrinkage effect in a cross-shaped partition wall and a T-shaped partition wall.

FIG. 4 is a plan-view diagram illustrating the relationship between partition wall structure and electrodes in a second embodiment.

FIG. 5 is a cross-sectional diagram of the conventional example of FIG. 1B along the address electrode direction.

FIG. 6 is a cross-sectional diagram of the second embodiment of FIG. 4B along the address electrode direction.

FIG. 7 is a plan-view diagram illustrating the relationship between partition wall structure and electrodes in a third embodiment.

FIG. 8 is a cross-sectional diagram of FIG. 7 along an address electrode.

FIG. 9 is a perspective-view diagram of the third embodiment.

FIGS. 10A and 10B are plan-view diagrams illustrating the relationship between partition wall structure and electrodes in a fourth embodiment.

FIG. 11 is a cross-sectional diagram of FIG. 10 along an address electrode.

### BEST MODE FOR CARRYING OUT THE INVENTION

Embodiments of the present invention are explained below with reference to accompanying drawings. The technical scope of the present invention, however, is not limited to these embodiments, and encompasses the subject matter set forth in the claims as well as equivalents thereof.

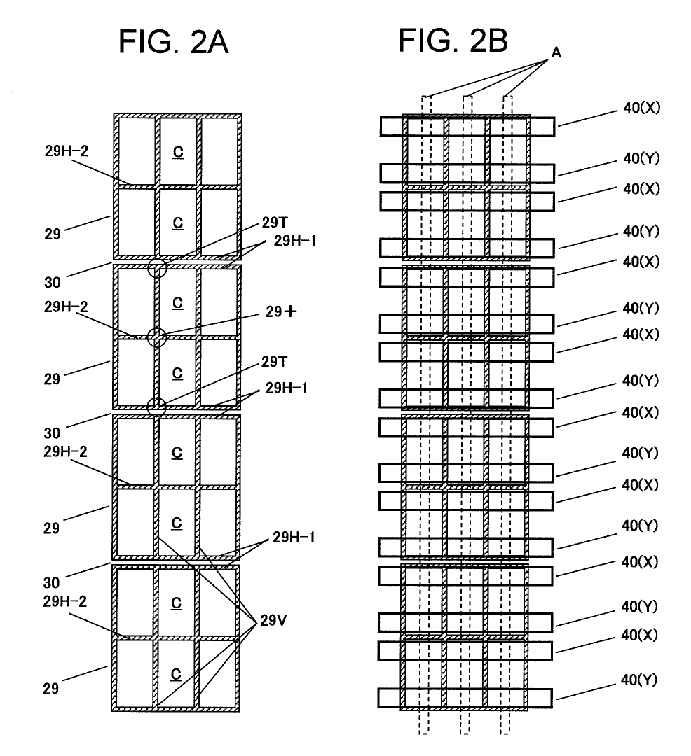

FIGS. 2A and 2B are plan-view diagrams illustrating the relationship between partition wall structure and electrodes in a first embodiment. FIG. 2A illustrates a lattice-like partition wall structure 29 that defines unit light-emitting regions (discharge cells) C. FIG. 2B illustrates display electrodes 40 and address electrodes A superposed on the lattice-like partition wall structure. FIGS. 2A and 2B illustrate a partition wall structure that defines 8 rows and 3 columns of unit light-emitting regions C. In actual panels, the partition wall structure defines, for instance, 1024 rows and 1024 columns of unit light-emitting regions in a 42-inch panel. Specific cross-sectional diagrams are described later. On a front side substrate there are formed the display electrodes 40, a protective layer and a dielectric layer covering the display electrodes 40. On a rear side substrate there are formed the address electrodes A, the lattice-like partition wall 29 that defines the unit light-emitting regions C, and phosphors of the three primary colors.

As illustrated in FIG. 2A, the partition wall structure 29 has transversal partition walls 29H extending in the transversal direction, and longitudinal partition walls 29V extending in the longitudinal direction. The unit light-emitting regions C are enclosed on four sides by the transversal partition walls 29H and the longitudinal partition walls 29V. The transversal partition walls 29H have first transversal partition walls 29H-1, separated in the longitudinal direction by gaps 30 running through in the transversal direction, and second partition transversal partition walls 29H-2 that are not separated by such gaps 30. The first transversal partition walls 29H-1 and the second partition transversal partition walls 29H-2 are provided alternately in the longitudinal direction. The longitudinal partition walls 29V connect one transversal wall of the first transversal partition walls 29H-1, the second partition transversal partition walls 29H-2, and one transversal wall of another first transversal partition walls 29H-1, to make up thereby one partition wall unit 29. FIG. 2A illustrates four partition wall units 29. Accordingly, one partition wall unit 29 forms two rows of unit light-emitting regions C. The partition wall units 29 are disposed separated from each other by gaps 30, running through in the transversal direction, in the first transversal partition walls 29H-1.

That is, the lattice-like partition walls have three transversal partition walls 29H-1, 29H-2, 29H-1 adjacent to each other, and a plurality of longitudinal partition walls 29V that connect these transversal partition walls. The partition wall units 29, which define each two rows of unit light-emitting regions C adjacent in the longitudinal direction, are arranged in a plurality, separated from one another by gaps 30 that run through in the transversal direction.

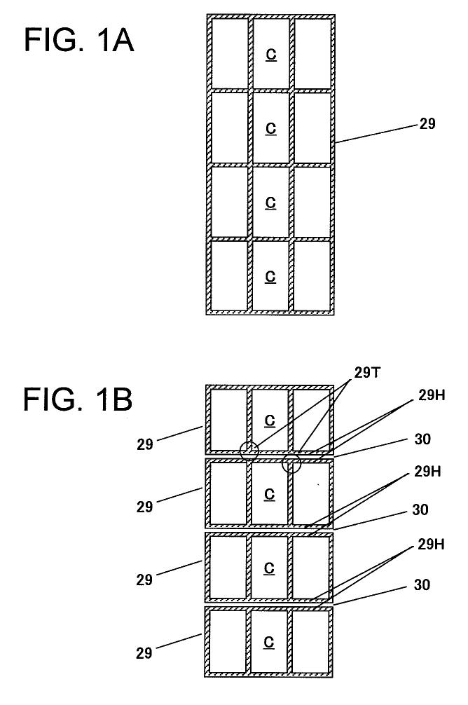

In the above partition wall structure, the unit light-emitting regions C can definitely be brought into contact with the gaps 30 above or below. Exhaust channels can thus be provided in all the unit light-emitting regions C up to vent holes (not shown), via gaps 30 having high exhaust conductance. This allows improving exhaust conductance during the sealing process. At the upper and lower edges of the partition wall units 29 there are formed T-shaped partition walls 29T, while cross-shaped partition walls 29+ are formed between the upper and the lower edges. Therefore, T shapes are not formed at all the intersection points of the lattice-like partition wall structure, and hence the influence of the collapse of the transversal partition walls 29H on account of thermal shrinkage can be kept to a minimum. That is, exhaust conductance is improved vis-á-vis that in FIG. 1A, while the number of transversal partition walls deforming as a result of thermal shrinkage can be reduced vis-á-vis that of FIG. 1B.

In the example of display electrodes 40 illustrated in FIG. 2B, a pair of display electrodes 40(X), 40(Y) is provided for each unit light-emitting region. The display electrodes 40 are formed ordinarily of a transparent electrode material. Bus electrodes, not shown, are formed in contact with the transparent electrodes. Surface discharge takes place upon alternating application of sustain discharge pulses between a pair of display electrodes 40(X), 40(Y). The UV rays generated as a result of the discharge excite the phosphor, which emits thereupon light of a respective color.

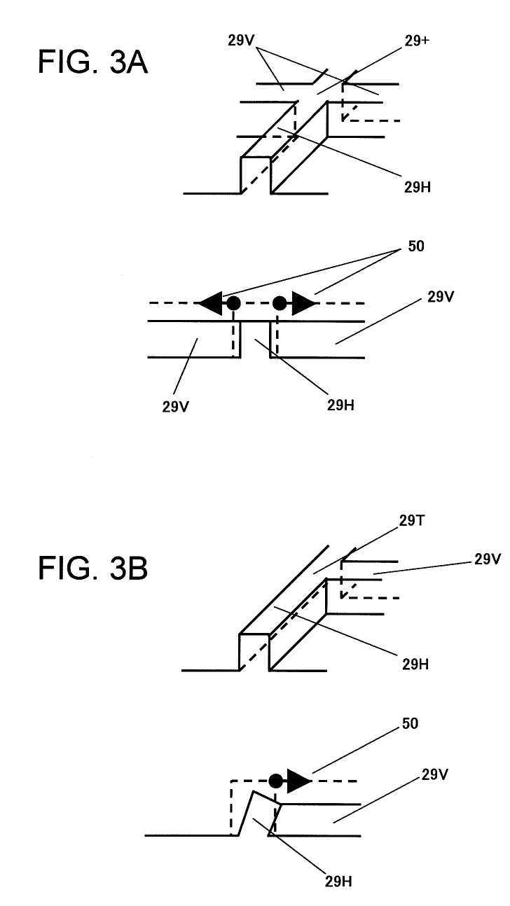

FIGS. 3A and 3B are diagrams illustrating the thermal shrinkage effect in a cross-shaped partition wall and a T-shaped partition wall. FIG. 3A is a perspective-view diagram and a cross-sectional diagram of a cross-shaped partition wall 29+. The partition walls are formed by printing repeated times, by screen printing, a low melting point glass paste on a substrate, to form a glass layer of predetermined thickness. A mask is then formed on the surface of the glass layer, and the glass layer is then patterned to a lattice-like pattern by sandblasting, followed by firing in a high-temperature atmosphere. A composition example of low melting point glass, which is the material of the partition walls, includes PbO (50 to 60 wt %), B₂O₃ (5 to 10 wt %), SiO₂ (10 to 20 wt %), Al₂O₃ (15 to 25 wt %) and CaO (up to 5 wt %). The thickness during printing is about 200 μm, and the firing temperature is about 500 to 600° C.

The partition wall shape shrinks on account of the thermal shrinkage that occurs during firing in such a high-temperature atmosphere. That is, the partition wall shape, represented by broken lines in the cross-sectional diagram, shrinks and deforms into the shape represented by the solid lines. In the case of the cross-shaped partition wall 29+, the two sides of a transversal partition wall 29H are connected to a longitudinal partition wall 29V, and hence the transversal partition wall 29H does not slant in the transversal direction even when under the tensile stress 50 that is generated by the thermal shrinkage of the longitudinal partition wall 29V.

FIG. 3B is a perspective-view diagram and a cross-sectional diagram illustrating a T-shaped partition wall 29T. In a T-shaped partition wall 29T, the terminal partition walls 29H are each connected to only one longitudinal direction partition wall 29V, and hence the partition wall shape represented by the broken line in the cross-sectional diagram deforms into a tilted shape, such as the one represented by the solid line, when thermal shrinkage 50 acts on the longitudinal partition wall 29. Therefore, the lattice-like partition wall structure has preferably as few T-shaped partition wall structures 29T as possible.

In the partition wall structure illustrated in FIG. 2, the T-shaped partition wall structures 29T and the cross-shaped partition wall structures 29+ are formed alternately, and hence the number of T shapes in each unit light-emitting region C can be reduced by half as compared with FIG. 1B. Moreover, gaps 30 having high exhaust conductance can be disposed at each row of the unit light-emitting regions, thereby improving exhaust characteristics.

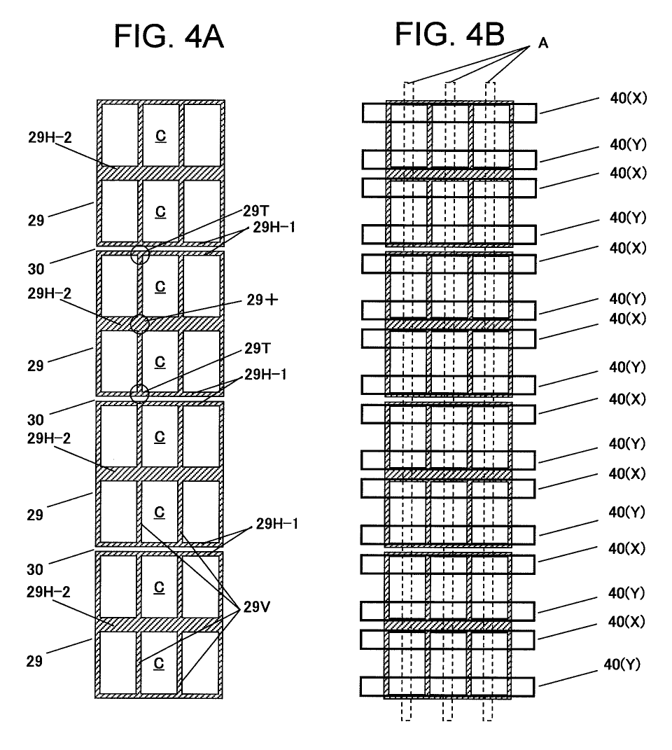

FIG. 4 is a plan-view diagram illustrating the relationship between partition wall structure and electrodes in a second embodiment. The second embodiment differs from the first embodiment illustrated in FIG. 2 in that herein the width W2 of the second partition transversal partition walls 29H-2 is larger than the widths of the transversal walls in the first transversal partition walls 29H-1 or than the width of the longitudinal partition walls 29V. As a result, the second partition transversal partition walls 29H-2, having a large width, are formed to a lower height than the height of the first transversal partition walls 29H-1 or the height of the longitudinal partition walls 29V. That is because the larger the partition wall width is, the greater its drop in height owing to thermal shrinkage. This results in a shape height, after thermal treatment, that is lower than that when the partition wall width is small. The underlying principle for this is explained in detail in Japanese Patent Application Laid-open No. 2002-83545, which is incorporated by reference.

Except for the above feature, the explanation for FIG. 2 applies to the present embodiment. Specifically, the unit light-emitting regions C are enclosed on four sides by the lattice-like partition wall structure, while first transversal partition walls 29H-1, separated from each other by gaps 30 running in the transversal direction, and second partition transversal partition walls 29H-2, not separated by gaps 30, are disposed alternately in the longitudinal direction. The arrangement of the display electrodes 40 and the address electrodes A illustrated in FIG. 4B is identical to that of FIG. 2.

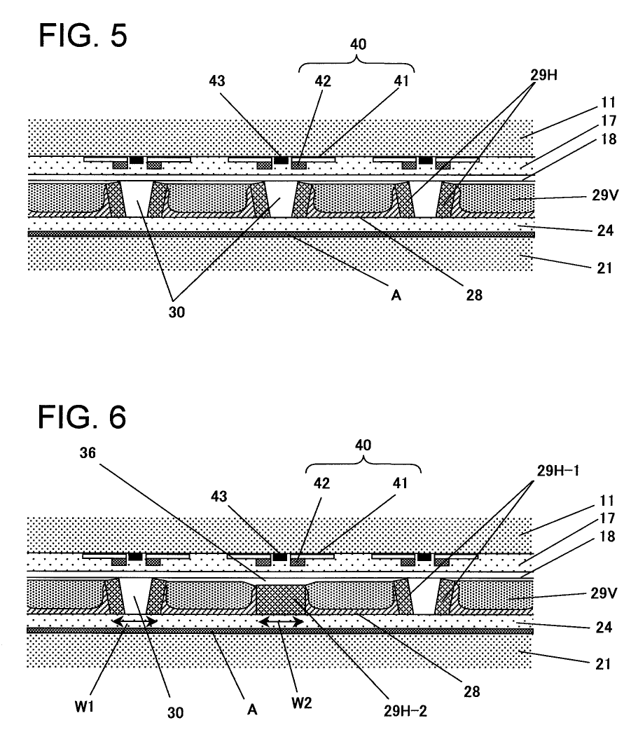

FIG. 5 is a cross-sectional diagram of the conventional example of FIG. 1B along the address electrode direction. FIG. 6 is a cross-sectional diagram of the second embodiment of FIG. 4B along the address electrode direction. The characterizing feature of the present embodiment will be explained by comparing both cross-sectional diagrams. The display electrodes 40, which are depicted only schematically in FIG. 4, are illustrated in greater detail in the cross-sectional diagram of the FIG. 6.

In an explanation of common features in FIG. 5 and FIG. 6, a plurality of display electrodes 40, each having a transparent electrode 41 of ITO or the like and a metal bus electrode 42 formed in contact with the transparent electrode 41, are formed on the surface of a front substrate 11. A pair of display electrodes 40 is disposed in each unit light-emitting region. A black layer 43, as a light-absorbing layer, is formed in an inverse-slit region (non-discharge region) between the pair of display electrodes 40. A dielectric layer 17 and a protective layer 18 are also formed. Meanwhile, address electrodes A are formed on the surface of a rear substrate 21, a dielectric layer 24 is formed on the address electrodes A, and a lattice-like partition wall 29 is formed on the dielectric layer. The cross-sectional diagrams in the figures depict the cross section of transversal partition walls 29H and the side face of a longitudinal partition wall 29V connected to the transversal partition walls 29H. A phosphor 28 is formed on the dielectric layer 24 climbing up the side walls of the partition wall 29. The phosphor 28 is thus formed in each of the regions, i.e. the unit light-emitting regions, enclosed by the partition wall 29.

In the following explanation on feature differences, all the transversal partition walls 29H are separated by gaps 30 running through in the transversal direction of the panel (direction perpendicular to the paper in the figure). Therefore, all the transversal partition walls 29H yield a T-shaped partition wall structure with the longitudinal partition walls 29V, and hence the transversal partition walls 29H are formed slanting towards the longitudinal partition walls 29V. This reduces as a result the opening ratio of the unit light-emitting regions that are flanked by the transversal partition walls 29H.

In the second embodiment of FIG. 6, by contrast, the first transversal partition walls 29H-1 separated by the gaps 30 are provided alternately with the second transversal partition walls 29H-2 not separated by the gaps 30. Therefore, although the first transversal partition walls 29H-1 are formed slanting in the up-and-down direction of the panel (left-right direction in FIG. 6), on account of their T shape, the second partition transversal partition walls 29H-2 do not slant thanks to their cross shape. The decrease in opening ratio on account of transversal partition wall slanting is improved thereby vis-á-vis the case in FIG. 5. Moreover, the gaps 30 running through in the transversal direction and separating the first transversal partition walls 29H-1 are in contact with each unit light-emitting region, whereby the exhaust conductance of the regions is improved.

Furthermore, the width W2 of the second partition transversal partition walls 29H-2 is larger than that of other partition walls, and hence the second partition transversal partition walls 29H-2 undergo greater thermal shrinkage, and exhibit thus a lower height, than the other partition walls. Small gaps 36 form as a result between the second partition transversal partition walls 29H-2 and the protective layer 18 on the side of the front substrate 11. These small gaps 36 contribute to improving exhaust conductance in the transversal direction and the longitudinal direction of the panel.

As illustrated in FIG. 6, the width W1 of the first transversal partition walls 29H-1 separated by the gaps 30 is identical to the width W2 of the second partition transversal partition walls 29H-2. The bus electrodes 42 and the black layers 43, having poor light transmissivity, can be disposed at these positions. As a result, the light from the phosphor 28 can be extracted through the front substrate without being blocked, which allows increasing emission efficiency.

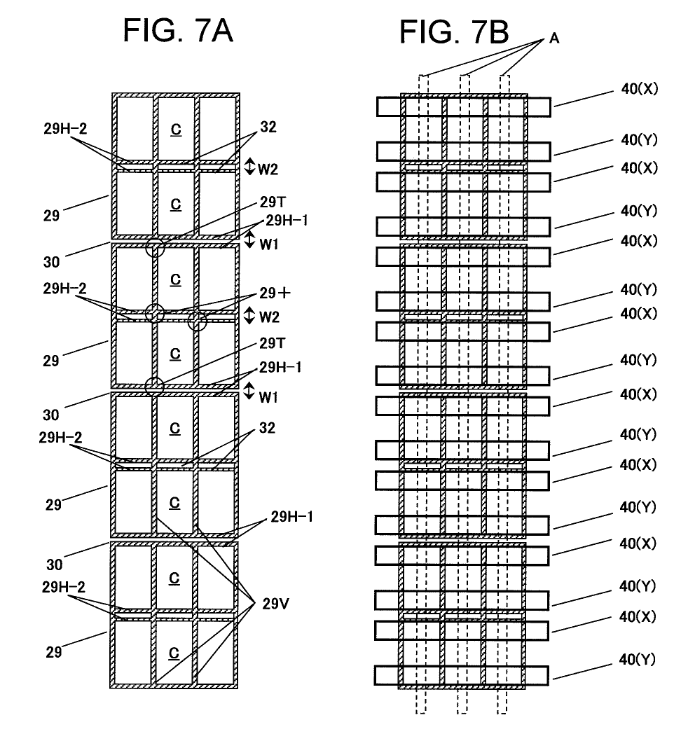

FIG. 7 is a plan-view diagram illustrating the relationship between partition wall structure and electrodes in a third embodiment. The embodiment in FIG. 7 differs from the plan-view diagram of FIG. 4 in that herein spaces 32 are provided within the second partition transversal partition walls 29H-2, in a plan view. Each space 32 is enclosed by one pair of sub-transversal walls (one pair of 29H-2) extending in the transversal direction, and a sub-longitudinal wall (part of 29V) that connects the pair of sub-transversal walls. In FIG. 7B the display electrode pairs and the address electrodes A of respective columns are depicted superposed on one another. Otherwise, the structure in FIG. 7 is the same as that of FIG. 4.

In the third embodiment, the total width W2 of the second partition transversal partition walls 29H-2 is greater than that of the longitudinal partition walls 29V and so forth. Even with spaces 32 now formed, the second partition transversal partition walls 29H-2 are formed to a lower height on account of thermal shrinkage.

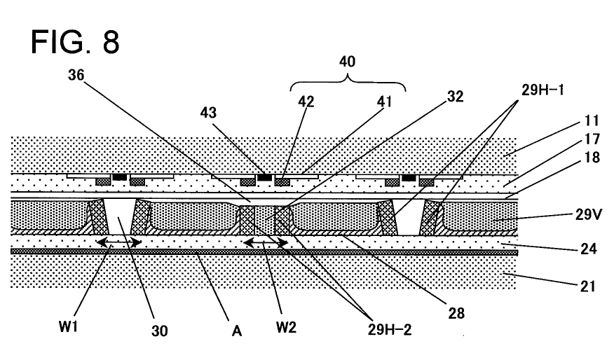

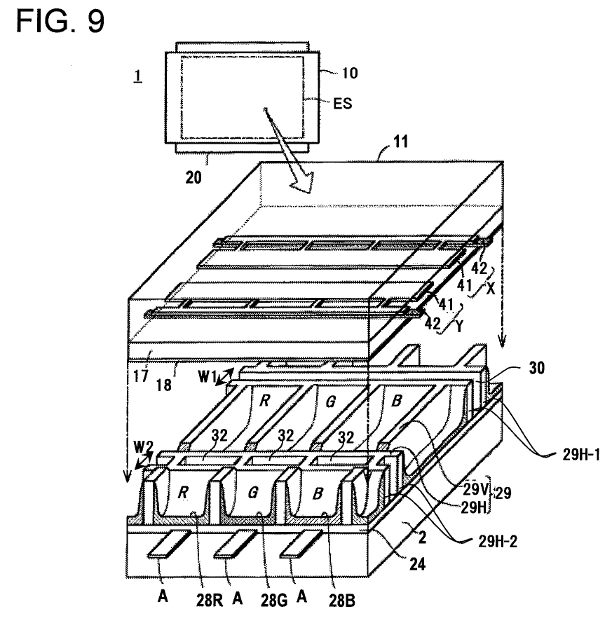

FIG. 8 is a cross-sectional diagram of FIG. 7 along an address electrode. FIG. 9 is a perspective-view diagram of the third embodiment. In an explanation of both figures, the structure of the cross-sectional diagram of FIG. 8 is identical to the structure of FIG. 6, except for the second partition transversal partition walls 29H-2. In FIGS. 8 and 9, the total width W2 of the second partition transversal partition walls 29H-2 is wider than that of other partition walls 29, as is the case in FIGS. 4 and 6. In FIGS. 8 and 9, spaces 32 are formed in the second partition transversal partition walls 29H-2. The spaces 32, which do not run through in the transversal direction, as do the gaps 30 that separate the first transversal partition walls 29H-1, but are divided by the longitudinal partition walls 29V. That is, each space 32 is enclosed by one pair of sub-transversal walls of the second partition transversal partition walls 29H-2 and the longitudinal partition walls 29V. The longitudinal partition walls 29V are thus connected. Therefore, the second partition transversal partition walls 29H-2 form cross shapes with the longitudinal partition walls 29V, whereby the second partition transversal partition walls 29H-2 do not collapse on account of thermal shrinkage. The total width W2 of the second partition transversal partition walls 29H-2 is wider, and thus the height of the second partition transversal partition walls 29H-2 is lower than that of the other partition walls, on account of thermal shrinkage.

In FIGS. 8 and 9, each unit light-emitting region C is provided with a pair of display electrodes 40, each having a transparent electrode 41 and a metallic bus electrode 42 formed in contact with the transparent electrode 41. A black layer 43 is formed in an inverse-slit region between the pair of display electrodes 40. The black layer 43, which is provided along the lattice-like partition wall 29, encloses the unit light-emitting region C, enhancing thereby contrast in the display image.

As can be clearly seen in the perspective-view diagram of FIG. 9, the gaps 30 running through in the transversal direction and separating the first transversal partition walls 29H-1 improve the exhaust conductance in each unit light-emitting region. Also, the height of the second transversal partition walls 29H-2 becomes lower, which improves exhaust conductance both in the transversal and longitudinal directions.

The capacitance of the display electrodes 40 relative to the address electrodes A is reduced by the gaps 30 of the first transversal partition walls 29H-1 and the spaces 32 of the second partition transversal partition walls 29H-2. That is, the bus electrodes 42 of the display electrodes 40 are formed, in particular, so as to overlap with the above-described transversal partition walls 29H-1, 29H-2. Since the permittivity of the gaps 30 and the spaces 32 is lower that of the partition walls 29H-1, 29H-2, which are made of glass material, the capacitance between the display electrodes 40 and the address electrodes A is reduced. This allows curbing as a result power consumption during display electrode driving.

Except for the structure of the second partition transversal partition walls 29H-2, the perspective-view diagram of FIG. 9 is identical to that of the first and second embodiments. In the perspective-view diagram of FIG. 9, a PDP 1 has a front-side substrate structure 10 and a rear-side substrate structure 20 sealed with a discharge space therebetween. The front-side substrate structure 10 has the display electrodes and so forth formed on the front substrate 11, while the rear-side substrate structure 20 has the address electrodes, partition walls, phosphor and so forth formed on the rear substrate 21. The plan-view diagram illustrates only a portion of a display region ES.

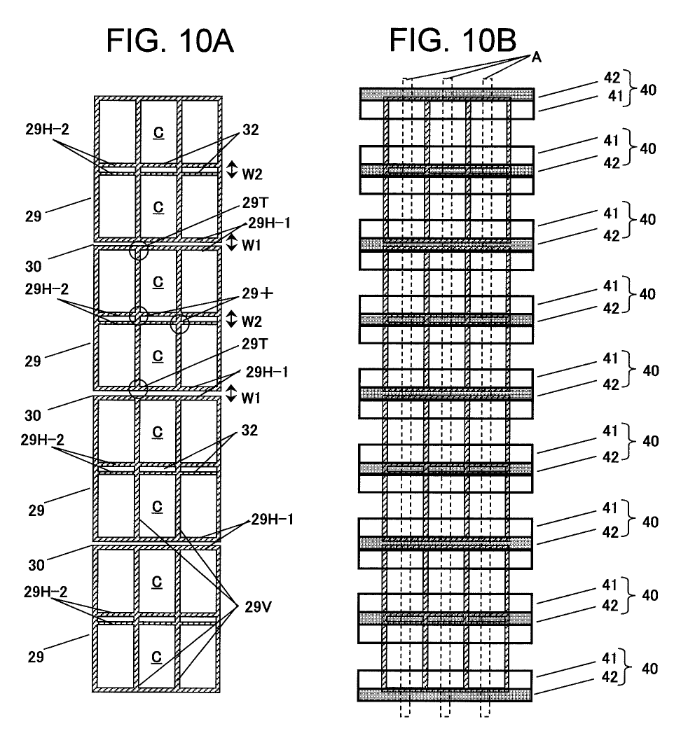

FIGS. 10A and 10B are plan-view diagrams illustrating the relationship between partition wall structure and electrodes in a fourth embodiment. The partition wall structure illustrated in FIG. 10A is identical to the partition wall structure of FIG. 7. However, the structure of the display electrodes 40 illustrated in FIG. 10B differs from that of the display electrodes 40 illustrated in FIG. 7B. In the example of FIG. 10B, specifically, the transparent electrodes 41 and the bus electrodes 42 share each adjacent unit light-emitting regions C in the up-and-down direction. That is, the unit light-emitting regions C are positioned each between the plural display electrodes 40 that are formed extending in the transversal direction. The metal bus electrodes 42 are disposed at positions overlapping with the first transversal partition walls 29H-1 and the second partition transversal partition walls 29H-2.

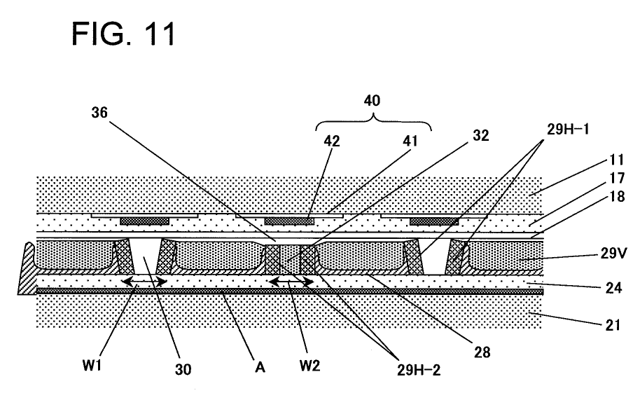

FIG. 11 is a cross-sectional diagram of FIG. 10 along an address electrode. The display electrode structure in the fourth embodiment is clearly revealed by comparing the cross-sectional diagram of FIG. 11 and the cross-sectional diagram of FIG. 8. The display electrodes 40 formed on the front-side substrate 11 are constituted by transparent electrodes 41 made of ITO or the like, and metal bus electrodes 42 layered at the central portion of the transparent electrodes 41. The display electrodes 40 are formed in such a manner that the two sides of the bus electrodes 42 come into contact with the transparent electrodes 41. As the cross-sectional diagram clearly shows, the display electrodes 40 are shared by adjacent unit light-emitting regions. The unit light-emitting regions C are thus formed completely between adjacent display electrodes 40, which allows as a result providing high-definition images.

The bus electrodes 42 are formed at positions at which the first transversal partition walls 29H-1 and the second partition transversal partition walls 29H-2 are formed on the rear-side substrate 21. The first and second partition transversal partition walls 29H-1, 29H-2 have, respectively, gaps 30 that run along the transversal direction, and spaces 32 that do not. As a result, the capacitance between the bus electrodes 42 and the address electrodes A is lowered on account of the gaps 30 and the spaces 32.

In the fourth embodiment as well, the first transversal partition walls 29H-1, separated by the gaps 30 running through in the transversal direction, are provided alternately with the second partition transversal partition walls 29H-2 having a wide overall width W2. The gaps 30 improve as a result the exhaust conductance in the unit light-emitting regions. Also, the height of the second partition transversal partition walls 29H-2 is made lower, thereby improving exhaust conductance, although not to the degree afforded by the gaps 30. Moreover, T-shaped partition wall structures 29T are formed only at the first transversal partition walls 29H-1. This allows reducing the number of collapses brought about by the T shapes, and allows keeping to a minimum drops in emission efficiency.

In the above-described embodiments, thus, the transversal partition walls of a lattice-like partition wall enclosing a unit light-emitting region has the first transversal partition walls 29H-1 having the gaps 30 running through in the transversal direction and the second partition transversal partition walls 29H-2 having no run-through gaps 30, the first transversal partition walls 29H-1 and the second partition transversal partition walls 29H-2 being provided alternately. The number of T-shaped partition wall shapes can be reduced thereby, while the run-through gaps 30 allow improving exhaust conductance. Nonuniform exhaust is thereby curbed in large-screen PDPs, enabling moisture and organic compounds in the interior to be sufficiently evacuated, while suppressing luminance unevenness.

1. A plasma display panel having a discharge gas sealed in a space between a pair of opposing substrates, comprising:
a plurality of display electrodes extending in a transversal direction, and address electrodes extending in a longitudinal direction and intersecting the display electrodes, which are provided on the pair of substrates; and
a lattice-like partition wall, formed on one substrate of the pair of substrates, and having longitudinal partition walls and transversal partition walls defining unit light-emitting regions where the display electrodes and address electrodes intersect each other,
wherein the transversal partition walls of the lattice-like partition wall comprise first transversal partition walls each separated by gap running through in a transversal direction, and second transversal partition walls that are not separated by gap running through in the transversal direction, the first transversal partition walls and the second transversal partition walls being provided alternately, and
a pair of the first transversal partition walls and a second transversal partition wall therebetween are connected by the longitudinal partition wall to form a partition wall unit, the partition wall units being disposed separated from each other by the gaps running through in the transversal direction.

2. The plasma display panel according to claim 1, wherein the width of the second transversal partition walls is greater than the width of the first transversal partition walls or the width of the longitudinal partition walls, and the height of the second transversal partition walls is lower than the height of the first transversal partition walls or the height of the longitudinal partition walls.

3. The plasma display panel according to claim 2, wherein spaces are provided in the second partition transversal partition walls, in a plan view, and the spaces are surrounded by one pair of sub-transversal walls extending in the transversal direction, and by sub-longitudinal walls that connect the pair of sub-transversal walls.

4. The plasma display panel according to claim 2,
wherein a pair of display electrodes and one address electrode are disposed in each of the unit light-emitting regions,
the display electrodes each comprise a transparent electrode and a bus electrode in contact with the transparent electrode, and
the bus electrodes of the display electrodes are disposed so as to overlap with the second transversal partition walls.

5. The plasma display panel according to claim 4,
wherein display electrodes disposed in adjacent unit light-emitting regions in the longitudinal direction are made common.

6. The plasma display panel according to claim 4,
wherein display electrodes disposed in adjacent unit light-emitting regions in the longitudinal direction are electrically separated, and a pair of display electrodes is disposed in each of the unit light-emitting regions.

7. The plasma display panel according to claim 1,
wherein a pair of display electrodes and one address electrode are disposed in each of the unit light-emitting regions,
the display electrodes each comprise a transparent electrode and a bus electrode in contact with the transparent electrode, and
the bus electrodes of the display electrodes are disposed so as to overlap with the first transversal partition walls and the second transversal partition walls.

8. A plasma display panel having a discharge gas sealed in a space between a pair of opposing substrates, comprising:
a plurality of display electrodes extending in a transversal direction, and address electrodes extending in a longitudinal direction and intersecting the display electrodes, which are provided on the pair of substrates; and
a lattice-like partition wall, formed on one substrate of the pair of substrates, and comprising longitudinal partition walls and transversal partition walls defining unit light-emitting regions where the display electrodes and address electrodes intersect each other,
wherein the lattice-like partition wall comprises three mutually adjacent transversal partition walls and a plurality of the longitudinal partition walls connecting the three transversal partition walls, and
partition wall units, which define two rows of adjacent unit light-emitting regions in the longitudinal direction, are arranged in a plurality, separated from one another by gaps running through in the transversal direction.

9. The plasma display panel according to claim 8, wherein a middle transversal partition wall of the three transversal partition walls has a wider width and a lower height than the other transversal partition walls.

10. The plasma display panel according to claim 9, wherein the middle transversal partition wall of the three transversal partition walls has intermittent spaces extending in the transversal direction, and
the display electrodes are formed above the gaps running through in the transversal direction between the partition wall units, and above the intermittent spaces extending in the transversal direction, the unit light-emitting regions being positioned between the display electrodes.

11. The plasma display panel according to claim 3,
wherein a pair of display electrodes and one address electrode are disposed in each of the unit light-emitting regions,
the display electrodes each comprise a transparent electrode and a bus electrode in contact with the transparent electrode, and
the bus electrodes of the display electrodes are disposed so as to overlap with the second transversal partition walls.

12. The plasma display panel according to claim 11,
wherein display electrodes disposed in adjacent unit light-emitting regions in the longitudinal direction are made common.

13. The plasma display panel according to claim 11,
wherein display electrodes disposed in adjacent unit light-emitting regions in the longitudinal direction are electrically separated, and a pair of display electrodes is disposed in each of the unit light-emitting regions.
